(19) United States
(12) Patent Application Publication
(10) Pub. No.: US 2023/0124425 A1
(43) Pub. Date: Apr. 20, 2023

(54) LOAD-BEARING PLATE WITH CELLULAR STRUCTURE AND ITS MANUFACTURING PROCESS

(71) Applicant: ISOKON, D.O.O., SLOVENSKE KONJICE, Slovenske Konjice (SI)

(72) Inventor: Iztok Svab, Celje (SI)

(21) Appl. No.: 17/910,783

(22) PCT Filed: Mar. 12, 2021
(86) PCT No.: PCT/SI2021/050010

§ 371 Date: Sep. 9, 2022

(30) Foreign Application Priority Data
Mar. 12, 2020 (SI) P-202000047

(51) Int. Cl. E01C 9/08; B32B 3/12; B32B 27/32; B29C 43/18; B29C 43/00; E01C 5/20; E01F 3/00

(52) U.S. Cl. CPC E01C 9/086; B32B 3/12; B32B 27/32; B29C 43/18; B29C 43/006; E01C 5/20; E01F 3/00; B29K 2715/003; B29K 2023/06; B32B 2307/72; B29K 2023/12

(57) ABSTRACT

The subject of the invention is a support panel with cellular core structure and the manufacturing process for the support panel with cellular core structure which solve the technical problems of: facilitating the manufacture of the product, ensuring compactness of individual panels and manufacturing support panels with cellular structure (1) in a single step. The support plate with cellular structure (1) comprises at least the upper solid surface (2), the lower solid surface (3) and the cellular structure (4), whereby all of these components are made of any thermoplastic material; however, all of the components are made of the same material. The cellular structure (4) is constructed with energy directors (5) to prevent spacing between the cellular structure (4), the upper solid surface (2) and the lower solid surface (3). The pre-formed cellular core (4) is placed on the levelled thermoplastic material used to form the lower solid surface, after which the material is applied over the cellular core (4) up to the depth required to form the lateral surfaces and the upper solid surface (2). After heating and pressing the material, the support panel with cellular structure (1) is cooled under pressure, and then it is removed from the press mould.

### FIELD OF TECHNOLOGY

Load-bearing plates; load-bearing plates with cellular structure; interconnecting mats; manufacturing process for load-bearing plates; floor mats; pedestrian mats; road mats; ground protection mats; helicopter landing pads; construction plates.

### TECHNICAL PROBLEM

Load-bearing plates with cellular structure are typically made of several pieces with the two main upper and lower components formed by pressing, injection moulding or other methods. The individual components of the load-bearing plates are then assembled using mechanical fasteners, thermal treatment, welding or other known methods or any combination of known methods.

The load-bearing plate with cellular structure presented in this invention is manufactured in a single step by means of pressing, whereby a supporting surface with solid external surfaces and hollow cellular structure of the core is formed. The invention also describes the process that makes it possible to manufacture the load-bearing plate with cellular structure in a single step. The new method of production described avoids the need to attach several components to assemble and form a supporting surface.

### STATE OF THE ART

There are several types of reusable load-bearing plates systems for the construction of supporting surfaces, which can be used to design temporary roadway, vehicular, pedestrian, road and/or working surfaces. Such load-bearing plate systems are generally made of durable materials, have surface structures to improve their traction, are joined together, and can be easily deployed and dismantled. When the load-bearing plate systems are installed, they provide a stable supporting surface for movement of vehicles, equipment and/or people or a working surface that can carry high loads. Load-bearing plates which are part of the load-bearing plate systems can be constructed as full or monolithic load-bearing plates or with cellular structure or other type of core structure. Monolithic plates have significantly greater weight, more material is used for their manufacture, and they do not provide high level of stiffness or load-bearing capacity, which means that they can deflect under load. Compared to monolithic load-bearing plates, load-bearing plates with cellular structure provide greater stiffness and provide a more stable and even working surface.

load-bearing plates with cellular structure are typically made of several pieces, with the two main upper and lower components formed by pressing, injection moulding or other procedures, and are then assembled together with mechanical fasteners, welding, other procedures or any combination of methods. There are several ways in which individual load-bearing plate components can be assembled into a single unit.

### DESCRIPTION OF NEW INVENTION

The subjects of the invention are:
a load-bearing plate with cellular structure and
a manufacturing process for load-bearing plate with cellular structure,
   which solve the technical problems of:
facilitating the manufacture of the product, since it is not necessary to assemble individual load-bearing plates with line or point connection;
ensuring compactness of individual plates, since individual components are not interconnected with point and/or line connection;
manufacturing load-bearing plates with cellular structure in a single step.

A load-bearing plate with cellular structure comprises at least the upper solid surface, lower solid surface and cellular core structure.

The upper solid surface, the lower solid surface and the cellular structure are all made of the same material, which can be any solid thermoplastic material, preferably polyethylene (PE) or polypropylene (PP).

The cellular structure is made of solid material and can be constructed in any way, but preferably by extrusion or machining from full material or injection moulding. The cellular structure part of the required dimensions is prepared in advance.

The cellular structure can be of any shape and is constructed with energy directors to improve connectivity or additionally prevent spacing between the cellular structure, upper solid surface and lower solid surface.

The cellular structure can be constructed with hollow cells aligned in such a way that the axis of the hollow cells is parallel or perpendicular to the planes of the upper solid surface and lower solid surface, or the hollow cells are positioned in such a way that the axis of the hollow cells is parallel to the planes of the upper solid surface and lower solid surface in certain parts but perpendicular in other parts.

The design, dimensions and material of the upper solid surface, lower solid surface and cellular structure are optimised to achieve required mechanical properties of the load-bearing plate with cellular structure.

Before filling the thermoplastic material into the moulds, the moulds are pre-heated to a temperature preferably ranging between 80° C. and 110° C. The lower and upper mould are pre-heated. The lateral frames of the tool are preferably not pre-heated and remain cold.

In the manufacturing process for the load-bearing plate with cellular structure, the thermoplastic material is spread over the bottom of the pre-heated mould up to the height that is appropriate to form the lower solid surface. The thermoplastic material is levelled to an even height. The density of the thermoplastic material ranges between 900 and 1100 kg/m³.

The thermoplastic material for the lower solid surface and upper solid surface can be in any form, preferably in powder form.

The lower solid surface and/or upper solid surface can be smooth or at least one of them is constructed with structural designs on the external surfaces to provide traction, preferably to provide better grip and traction of vehicle wheels on transport vehicles, to prevent the wheels from slipping.

A pre-formed cellular core, which is made of the same material, is placed on the heated levelled thermoplastic material, preferably intended to form a lower solid surface. The elements of the cellular core are positioned on a predefined distance from the lateral edge of the mould.

When the cellular core is positioned, the same material as used to form the lower solid surface is applied inside the tool mould on and along the pre-formed cellular core up to the depth required to form the lateral surfaces and upper solid surface. The thermoplastic material is evenly spread to the required depth over the upper surface.

If the axis of the cellular core is perpendicular to the plane of the upper solid surface, a partition in the form of a thermoplastic film or in any other form is placed over the cellular cores to prevent the thermoplastic material intended for shaping the upper solid surface from filling the cells of the cellular core. Various materials can be used to manufacture the components of the load-bearing plate with cellular structure; however, all the components of the load-bearing plate with cellular structure are made of the same material.

The upper and lower moulds are heated to a set temperature, preferably ranging between 150° C. and 200° C. The press closes the moulds with a pre-set pressing force for a specified time, according to the required product dimensions, to compression mould the thermoplastic material. The load-bearing plate surfaces and cellular structure are bonded together using required pressure and temperature cycle time necessary for the thermoplastic material.

Subsequently, the heating of the lateral frames of the tool is included, with the temperature being set separately, and they are heated until the end of the heating cycle.

During the manufacture of the load-bearing plates with cellular structure, the surfaces of the heated mould press the material using the pressure and temperature required so as to achieve melting of only the material surrounding the pre-formed cellular structure in order to bond this molten material with the pre-formed cellular structure.

The heated material that forms upper and lower solid surfaces and the material along the lateral surfaces of the cellular structure bonds with the cellular structure and energy directors on the cellular structures.

The load-bearing plate with cellular structure is then cooled for a specified time and pressure, depending on the mass, volume and distribution of material.

When the temperature of the product in the mould drops to a specified value, the pressing force or pressure is increased and the surface applies pressure on the load-bearing plate with cellular structure for a pre-set time, after which the pressure is decreased again and the load-bearing plate with cellular structure is further cooled at the required pressure.

After the cooling step, the load-bearing plate with cellular structure is removed from the press mould.

Load-bearing plates with cellular structure manufactured in a single step are more rigid and prevent movement between components, since the individual components are connected by surface bonding instead of line or point connections as is the case with load-bearing plates that require assembly from two or more components.

load-bearing plates with cellular structure or tools for manufacturing load-bearing plates with cellular structure can be designed to allow the manufacture of load-bearing plates with or without overlaps. The tools can be of different dimensions according to the required final dimensions of load-bearing plate with cellular structure.

The load-bearing plates with cellular structure can also be used as floor plates or wall load-bearing plates or for other purposes.

The essence of the invention is further explained below with the description of the embodiment and attached figures, whereby the figures are part of this patent application and show the following:

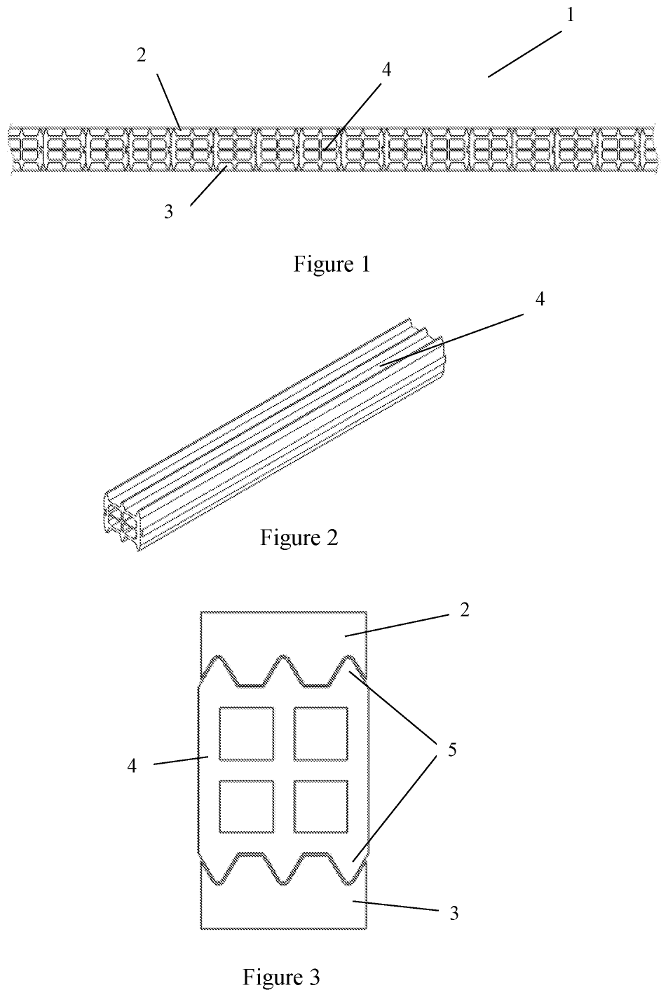

FIG. 1 shows a load-bearing plate with cellular structure 1, an upper solid surface 2, a lower solid surface 3 and a cellular structure 4.

FIG. 2 shows a cellular structure 4.

FIG. 3 shows an upper solid surface 2, a lower solid surface 3, a cellular structure 5 and energy directors 5.

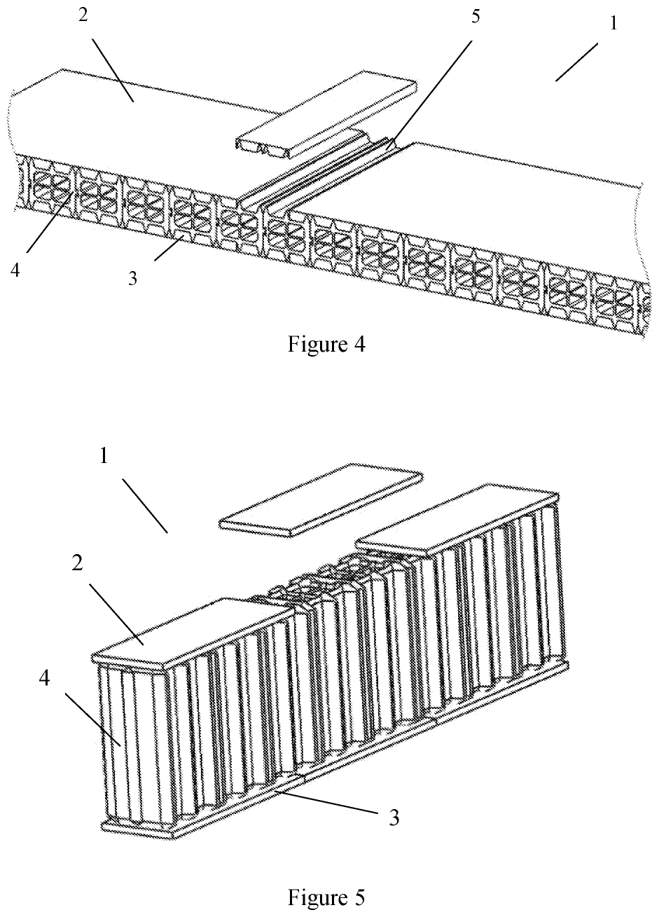

FIG. 4 shows a load-bearing plate with cellular structure 1, an upper solid surface 2, a lower solid surface 3, a cellular structure 4 and energy directors 5.

FIG. 5 shows a load-bearing plate with cellular structure 1, an upper solid surface 2, a lower solid surface 3 and a cellular structure 4.

### EXEMPLARY EMBODIMENT

The load-bearing plate with cellular structure 1 is constructed without overlaps and measures 4000×2000×60 mm.

The upper solid surface 2, the lower solid surface 3 and the cellular structure 4 are made of polyethylene. The cellular structure 4 is made by extrusion and is constructed with energy directors 5 to improve bonding to the material used to form the upper and lower surface as well as preventing spacing between the cellular structure 4, upper solid surface 2 and lower solid surface 3. The cellular structure 4 is constructed with directional hollow cells in such a way that the axis of the hollow cells is perpendicular to the planes of the upper solid surface 2 and lower solid surface 3.

Before filling the polyethylene into the tools, the tools are pre-heated to 100° C. The lower and upper tool are pre-heated, while the lateral frames remain cold.

8 kg/m² polyethylene in powder form with a density of 960 kg/m³ is spread over the bottom of the pre-heated tool and is levelled to an even height.

The lower solid surface 3 and the upper solid surface 2 are constructed with structural designs or grips on external surfaces to provide better traction of wheels on transport vehicles.

A pre-formed cellular structure 4 with the profile height of 55 mm is placed on a heated levelled polyethylene material. The elements of the cellular core are positioned 10 cm from each lateral edge of the tool.

When the cellular structure 4 is positioned, 8 kg/m² of polyethylene with a density of 960 kg/m³ is applied inside the tool mould on and along the pre-formed cellular core to form the lateral surfaces and the upper solid surface 2. Polyethylene is evenly spread over the upper surface.

The upper surface is heated to 180° C., and the lower surface is heated to 160° C. Lateral heating frames are not heated at the beginning of the process. Initial pressures are set to a minimum pressure of 20 bar to close the press. The heating cycle time for pressing is 50 minutes. After 30 minutes of heating, lateral frames are heated with a temperature of 170° C. until the end of the heating cycle. The pressure remains at the minimum level during heating. After 48 minutes of heating, the lower plate of the tool is switched off and after 50 minutes the upper plate of the tool is switched off, after which the heating cycle comes to an end. The load-bearing plate with cellular structure 1 is then cooled for 15 minutes under at minimum pressure.

When the temperature of the product drops below 90° C., the pressure increases to 90 bars for 10 minutes, after which the pressure decreases again to a minimum pressure of the tool and the load-bearing plate with cellular structure 1 is further cooled for 30 minutes.

After cooling, the load-bearing plate with cellular structure is removed from the press mould.

It is self-evident that the above-described invention can be also used in other particular form without changing the substance of the invention.

1. The support plate with cellular core structure characterised in that it is made of thermoplastic material and comprises the upper solid surface (2), lower solid surface (3) and cellular core structure (4) constructed with energy directors (5), whereby the surfaces of the components are inseparably bonded together under controlled temperature and pressure with the melted thermoplastic material and all the components of the load-bearing plate with cellular structure (1) are made of the same material.

2. The invention according to claim 1, characterised in that all of the components of the load-bearing plate with cellular structure (1) are made of polyethylene.

3. The invention according to claim 1, characterised in that all of the components of the load-bearing plate with cellular structure (1) are made of polypropylene.

4. The invention according to claim 1, characterised in that the cellular structure (4) is constructed with directional hollow cells in such a way that the axis of the hollow cells is perpendicular to the planes of the upper solid surface (2) and lower solid surface (3).

5. The invention according to claim 1, characterised in that the cellular structure (4) is constructed with directional hollow cells in such a way that the axis of the hollow cells is parallel to the planes of the upper solid surface (2) and lower solid surface (3).

6. The invention according to claim 1, characterised in that the cellular structure (4) is constructed with directional hollow cells in such a way that the axes of the hollow cells are perpendicular to the planes of the upper solid surface (2) and lower solid surface (3) in certain parts and parallel in other parts.

7. The invention according to claim 1, characterised in that the density of the thermoplastic material ranges between 900 and 1100 kg/m3.

8. The invention according to claim 1, characterised in that the thermoplastic material for the lower solid surface (3) and upper solid surface (2) is in powder form.

9. The invention according to claim 1, characterised in that the upper solid surface (2) is constructed with structural designs on the external surface.

10. The invention according to claim 1, characterised in that the lower solid surface (3) is constructed with structural designs on the external surface.

11. The manufacturing process for load-bearing plate with cellular structure characterised in that the thermoplastic material is evenly spread over the bottom of the press mould up to the height that is appropriate to form the lower solid surface (3), after which the pre-formed cellular core (4) is placed on the heated thermoplastic material and the thermoplastic material is applied inside the mould on and along the pre-formed cellular core (4) up to the depth required to form the lateral surfaces and upper solid surface (2); the thermoplastic material is then evenly levelled on the upper surface and the press tool presses the introduced components at a set temperature and forms the load-bearing plate with cellular structure (1).

12. The process according to claim 11, characterised in that before introducing the thermoplastic material into the tools, the tools are pre-heated to a temperature ranging between 80° C. and 110° C.

13. The process according to claim 11, characterised in that the lower and upper tool are pre-heated.

14. The process according to claim 11, characterised in that the lateral frames are not pre-heated.

15. The process according to claim 11, characterised in that the cellular structure (4) is made by extrusion.

16. The process according to claim 11, characterised in that the cellular structure (4) is made by machining from full material.

17. The process according to claim 11, characterised in that the cellular structure (4) is made by injection moulding.

18. The process according to claim 11, characterised in that the elements of the cellular core are positioned at a predefined distance from the lateral edge of the tool.

19. The process according to claim 11, characterised in that a thermoplastic film is placed on the cellular cores to prevent the thermoplastic material intended for shaping the upper solid surface (2) from filling the cells of the cellular core.

20. The process according to claim 11, characterised in that the upper and lower tool are heated to a set temperature ranging between 150° C. and 200° C.

21. The process according to claim 11, characterised in that the heating of the lateral frames of the tool is subsequently undertaken, with the temperature being set independently, and they are heated until the end of the heating cycle.

22. The process according to claim 11, characterised in that during the manufacture of load-bearing plates with cellular structure (1), the surface of the heated tool presses on the material with an appropriate minimum pressure so as to soften or melt only the material surrounding the pre-formed cellular structure (4) in order to bond this molten material with the pre-formed cellular structure (4).

23. The process according to claim 11, characterised in that heat melts material of the upper solid surface (2), lower solid surface (3) and the material along the lateral surfaces of the cellular structure (4) to bond with the cellular structure (4) and energy directors on the cellular structures (5).

24. The process according to claim 11, characterised in that the load-bearing plate with cellular structure (1) is cooled for an appropriate time under a set pressure after the heating process.

25. The process according to claim 11, characterised in that during the manufacture of the load-bearing plate with cellular structure (1), the temperature during the cooling of the product drops to a specified value, the pressing force or pressure increases and the surface applies pressure on the load-bearing plate with cellular structure (1) for a pre-set time, after which the pressure decreases again and the load-bearing plates with cellular structure (1) is further cooled at a minimum pressure.

26. The process according to claim 11, characterised in that the elements of the cellular core are positioned at a predefined distance from the lateral edge of the tool.
